(19) United States
(12) Patent Application Publication
(10) Pub. No.: US 2024/0095799 A1
(43) Pub. Date: Mar. 21, 2024

(54) PROCESSING DEVICE, PROCESSING METHOD, AND PROCESSING PROGRAM

(71) Applicant: NTT QONOQ, INC., Chiyoda-ku (JP)

(72) Inventors: Toshimitsu NAKAMURA, Chiyoda-ku (JP); Misa YAMAZAKI, Chiyoda-ku (JP); Sachiyo KAWAHARA, Chiyoda-ku (JP)

(73) Assignee: NTT QONOQ, INC., Chiyoda-ku (JP)

(21) Appl. No.: 18/262,335

(22) PCT Filed: Jan. 21, 2022
(86) PCT No.: PCT/JP2022/002218

§ 371 Date: Jul. 20, 2023

(30) Foreign Application Priority Data
Jan. 22, 2021 (JP) 2021-009103

(51) Int. Cl. G06Q 30/0601

(52) U.S. Cl. CPC G06Q 30/0623; G06F 3/04815

(57) ABSTRACT

A server apparatus (10) includes: a building unit (132) configured to build a virtual shop at which a user's viewing and purchase of a product can be performed in a virtual space and provide the virtual shop for a user terminal used by each user; and an element of interest display control unit (134) configured to identify an element for which users' interests are aggregated among elements disposed in the virtual shop on the basis of operation information of each user for the virtual shop and perform control such that the identified element is displayed with being emphasized in each user terminal.

### TECHNICAL FIELD

The present invention relates to a processing device, a processing method, and a processing program.

### BACKGROUND ART

Conventionally, purchase of products using web sites (Electronic Commerce (EC) sites) selling products on the Internet is generally available. In addition, in recent years, technologies providing purchase experiences of the same degree as that of purchase of products at an actual shop for users by reproducing a shop in a virtual space and linking the shop with an EC site have been proposed.

### CITATION LIST

### Patent Literature

Patent Literature 1: Japanese Unexamined Patent Publication No. 2004-220074

### SUMMARY OF INVENTION

### Technical Problem

In an actual shop, it can be judged that products of interest be disposed at a place at which other purchasers gather, which may lead to viewing and purchase of the products of interest. However, inside a shop reproduced in a virtual space, products are only displayed, and it cannot be judged which products are drawing attention from purchasers, and products of interest cannot be judged unlike in an actual shop.

The present invention is in view of the description presented above, and an object thereof is to provide a processing device, a processing method, and a processing program capable of providing a smooth shopping environment for a user by enabling factors of interest in a virtual shop reproduced in a virtual space to be judged.

### Solution to Problem

In order to solve the problems described above, a processing device according to the present invention includes: a building unit configured to build a virtual shop at which a user's viewing and purchase of a product can be performed in a virtual space and provide the virtual shop for a user terminal used by each user; and a first control unit configured to identify an element which is attracting users' interest among elements disposed in the virtual shop on the basis of operation information of each user for the virtual shop and perform control such that the identified element is displayed by being emphasized in each user terminal.

### Advantageous Effects of Invention

According to the present invention, by enabling factors of interest in a virtual shop reproduced in a virtual space to be judged, a smooth shopping environment can be provided for a user.

### BRIEF DESCRIPTION OF DRAWINGS

FIG. 1 is a block diagram illustrating an example of the configuration of a communication system according to an embodiment.

FIG. 2 is a block diagram illustrating an example of the configuration of a server apparatus illustrated in FIG. 1.

FIG. 3 is a diagram illustrating an example of a screen displayed in a user terminal.

FIG. 4 is a sequence diagram illustrating a processing sequence of a communication process in a communication system according to an embodiment.

FIG. 5 is a diagram illustrating a computer executing a program.

### DESCRIPTION OF EMBODIMENTS

Hereinafter, a processing device, a processing method, and a processing program according to an embodiment of the present application will be described in detail with reference to the drawings. A processing device, a processing method, and a processing program according to the present application are not limited to this embodiment.

In the following embodiment, the processing flow of a processing device, a processing method, and a processing program according to the embodiment will be described in order, and finally effects according to the embodiment will be described.

### Embodiment

First, an embodiment will be described. In the embodiment, a communication system used for providing a shopping environment in a virtual space for a user will be described.

[Configuration of Communication System]

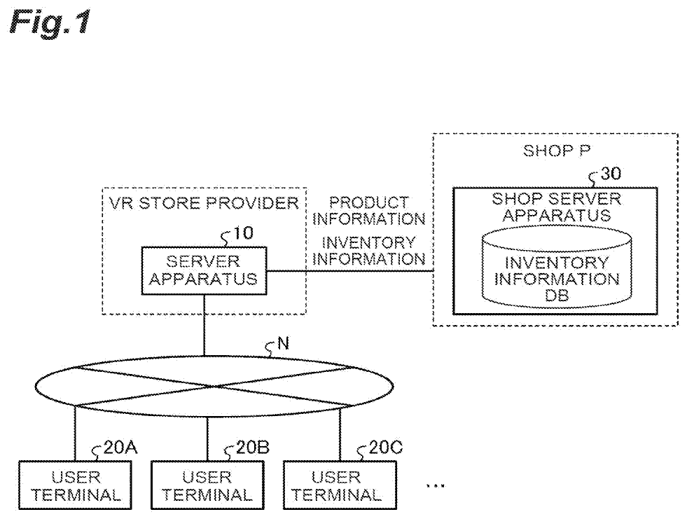

The configuration of a communication system according to an embodiment will be described. In the communication system according to the embodiment, in a server apparatus of a virtual reality (VR) store provider side providing a shopping environment for a user, a VR store is built in a virtual space, and products are disposed inside the VR store such that they can be viewed and purchased. FIG. 1 is a block diagram illustrating an example of the configuration of the communication system according to the embodiment.

As illustrated in FIG. 1, the communication system according to the embodiment includes user terminals 20A, 20B, and 20C used by respective users and a server apparatus 10 (a processing apparatus) of a VR store provider. The server apparatus 10 is connected to a shop server apparatus 30 of a shop P that sells products. In addition, the configuration illustrated in FIG. 1 is merely one example, and a specific configuration and the number of respective devices are not particularly limited.

The server apparatus 10 (the processing apparatus) of the VR store provider receives information of products that can be exhibited in a VR store or an advertisement from a shop server apparatus 30 of a shop P selling products and provides a VR store in which such products are displayed for users. In the VR store, by selecting a product, a user can refer to product information such as a type, a color, a size, a price, and the like of the product, and, by performing a predetermined process, the process can proceed up to a purchase process of the product. In addition, the server apparatus 10 can reproduce a virtual street in a virtual space, build a virtual shopping mall in which a plurality of VR stores and street advertisements are disposed in the street (a VR shopping mall), and provide the virtual shopping mall for users.

The shop server apparatus 30 has an inventory DB of maintained products. The shop server apparatus 30 transmits information of products that can be exhibited in a VR store and advertisements among maintained products to the server apparatus 10 through a network or the like. The shop server apparatus 30 transmits identification information, a name, a size, a color, a price, inventory information, and the like of products as information of the products.

The user terminals 20A, 20B, and 20C are information processing devices such as notebook personal computers (PC), desktop PCs, or the like or smart devices such as an electronic tablet, a smartphone, and the like. The user terminals 20A, 20B, and 20C are connected to the server apparatus 10 through a network N and are provided with a VR store. The user terminals 20A, 20B, and 20C allow viewing of products and advertisements and purchase of products to be performed inside the provided VR store. The user terminal 20A is a terminal that is used by a user A. The user terminal 20B is a terminal that is used by a user B. The user terminal 20C is a terminal that is used by a user C. The user terminals 20A, 20B, and 20C will be collectively referred to as a user terminal 20.

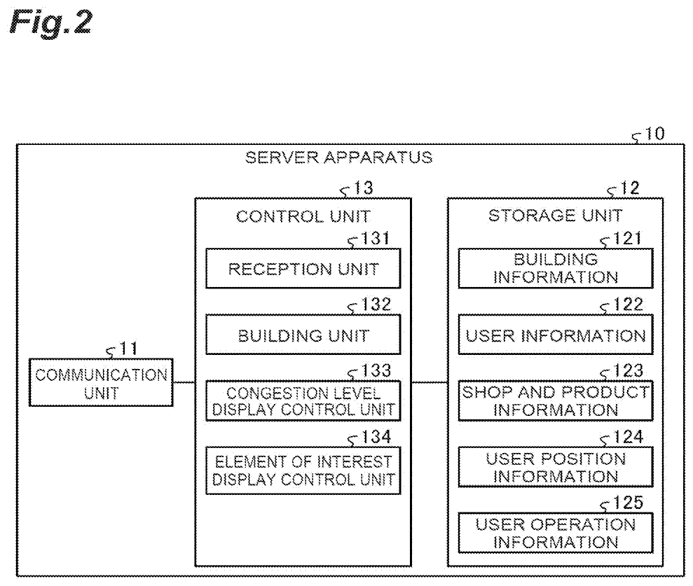

The server apparatus 10 identifies a product or an advertisement which is receiving users' interest among products or advertisements disposed in the VR store and emphasizes the identified product or advertisement in display in each user terminal 20. In accordance with this emphasized display, a user can judge one of products and advertisements that is drawing attention and can smoothly advance viewing, purchases, and the like of the product of interest. Subsequently, the server apparatus 10 illustrated in FIG. 1 will be described.

[Server apparatus] FIG. 2 is a block diagram illustrating an example of the configuration of the server apparatus 10 illustrated in FIG. 1. As illustrated in FIG. 2, this server apparatus 10 includes a communication unit 11 that controls communication relating to various kinds of information, a storage unit 12 that stores data and programs required for various processes performed by a control unit 13, and the control unit 13 that performs various processes. Hereinafter, the process of each unit included in the server apparatus 10 will be described.

The communication unit 11 is a communication interface that transmits/receives various kinds of information to/from other devices connected through a network or the like. The communication unit 11 is realized using a network interface card (NIC) or the like and performs communication between another device connected through a telecommunication line such as a local area network (LAN), the Internet, or the like and the control unit 13 (to be described below). For example, the communication unit 11 receives information of products that can be exhibited from the shop server apparatus 30 through a network. In addition, the communication unit 11 receives a request for shop opening in the VR store, a viewing request or a purchase request for a product, and operation information of each user for a virtual shop from the user terminals 20A, 20B, and 20C through a network N. The communication unit 11 transmits a purchase procedure of a product and information about inventory update after the product purchase to the shop server apparatus 30.

The storage unit 12 is a storage device such as a hard disk drive (HDD), a solid-state drive (SSD), or the like. In addition, the storage unit 12 may be a data-rewritable semiconductor memory such as a random access memory (RAM), a flash memory, a non-volatile static random access memory (NVSRAM), or the like. The storage unit 12 stores an operating system (OS) and various programs executed by the server apparatus 10. In addition, the storage unit 12 stores various kinds of information used for execution of programs. The storage unit 12 stores building information 121, user information 122, shop and product information 123, user position information 124, and user operation information 125.

The building information 121 is information that is necessary for building a VR store and a VR shopping mall in a virtual space. The building information 121 includes image processing conditions and an image processing program used for building a VR store and a VR shopping mall in a virtual space. In addition, in a case in which a VR store and a VR shopping mall are built using Photo VR or a Planet enabling a panoramic view of products in a space inside a 360° sphere, the building information 121 may include photographs acquired by capturing an in-shop view, products, a street landscape, an external shop view with a fixed point or 360° or images of the VR store and the VR shopping mall built by performing image processing of such photographs. For example, in a case in which a VR store and a VR shopping mall are built using computer graphics (CG), the building information 121 represents images reproducing an in-shop view, products, a street landscape, and an external shop view.

The user information 122 is information about each user registered in a VR store and a VR shopping mall as a customer. For example, the user information 122 includes an ID of each user and a purchase history and a viewing history associated with each user ID. For example, the purchase history has a purchase time, a name of a shop at which a product has been purchased, a product ID, a product name, a size, a color, and a quantity as items. For example, the viewing history has a viewing time, a name of a shop at which a product has been viewed, a product ID, a product name, a size, a color, and a quantity as items.

The shop and product information 123 is information about a shop disposed in a VR shopping mall and products exhibited inside a VR store. The shop and product information 123 has a store ID, a shop type, and a product ID, a product name, a size, a color, and a quantity of each of products that can be exhibited in a VR store or an advertisement among products maintained by each shop as items. For example, a shop P is a grocery store, and cutlery and cups as products that can be exhibited are represented together with features such as sizes, colors, and the like of such products and the quantity of inventories.

The user position information 124 is information in which position information of each of users A, B, and C in a virtual space transmitted from the user terminals 20A, 20B, and 20C is associated with time information. This user position information 124 is regularly updated.

The user operation information 125 is information in which operation information of each user transmitted from each of the user terminals 20A, 20B, and 20C is associated with time information. This user operation information 125 is regularly updated.

The control unit 13 controls the whole server apparatus 10. For example, the control unit 13 is an electronic circuit such as a central processing unit (CPU) or a micro processing unit (MPU) or an integrated circuit such as an application specific integrated circuit (ASIC) or a field programmable gate array (FPGA). In addition, the control unit 13 includes an internal memory for storing a program defining various processing sequences and control data and performs each process using the internal memory. Furthermore, in accordance with operations of various programs, the control unit 13 functions as various processing units. The control unit 13 includes a reception unit 131, a building unit 132, a congestion level display control unit 133 (a second control unit), and an element of interest display control unit 134 (a first control unit).

The reception unit 131 accepts entrance into a VR shopping mall, shop opening in a VR store inside the VR shopping mall, viewing of a product, and purchase of a product from a user.

The building unit 132 builds a VR store and a VR shopping mall in a virtual space using photo VR, Planet, or CG. When shop opening in a VR store is accepted from a user, the building unit 132 builds the VR store in the virtual space. Then, the building unit 132 provides the built VR store for the user terminal 20 used by the user.

In the VR store, an inner view is built on the basis of an actual shop, and products that can be exhibited among products maintained by the actual shop are displayed such that they are exhibited using an exhibition method of the inside of the actual shop (arrangement in one row in a display rack or the like). For each of the exhibited products, product information (a type, a color, a shape, a size, a price, and an inventory status) is provided to be able to be viewed. The exhibited products can be purchased as well. In addition, in the VR store, in an arbitrary area inside the shop, an advertisement of products and the like exhibited in the shop can be displayed as well. In the VR store, a user can move an avatar of the user such that it walks inside the actual shop.

Then, when entrance of a user into a VR shopping mall is received, the building unit 132 may acquire the building information 121 and build the VR shopping mall in a virtual space. In the VR shopping mall, on the basis of an actual street landscape, arrangement of each shop, an external view of each shop, roads, and corresponding advertisements are built. In the VR shopping mall, a user can move an avatar of the user such that the avatar walks on the actual street landscape. Then, in the VR shopping mall, for example, by clicking or tapping on a shop name or an entrance of a shop displayed in a shop external view, a user can enter the selected VR store.

In addition, when an entrance of a user into a VR shopping mall is received, the building unit 132 may also build each VR store disposed in the VR shopping mall together with the VR shopping mall. Furthermore, the building unit 132, for each season, may change a landscape of a street of the VR shopping mall, products exhibited in a VR store, and products displayed in advertisements.

The congestion level display control unit 133 acquires a congestion level of a VR store on the basis of position information of each user at the VR store. For example, as the congestion level, a density of users according to a size of the inside of a shop of the VR store in the virtual space is used. Then, the congestion level display control unit 133 performs control such that person images of the number corresponding to a congestion level is displayed in each user terminal 20.

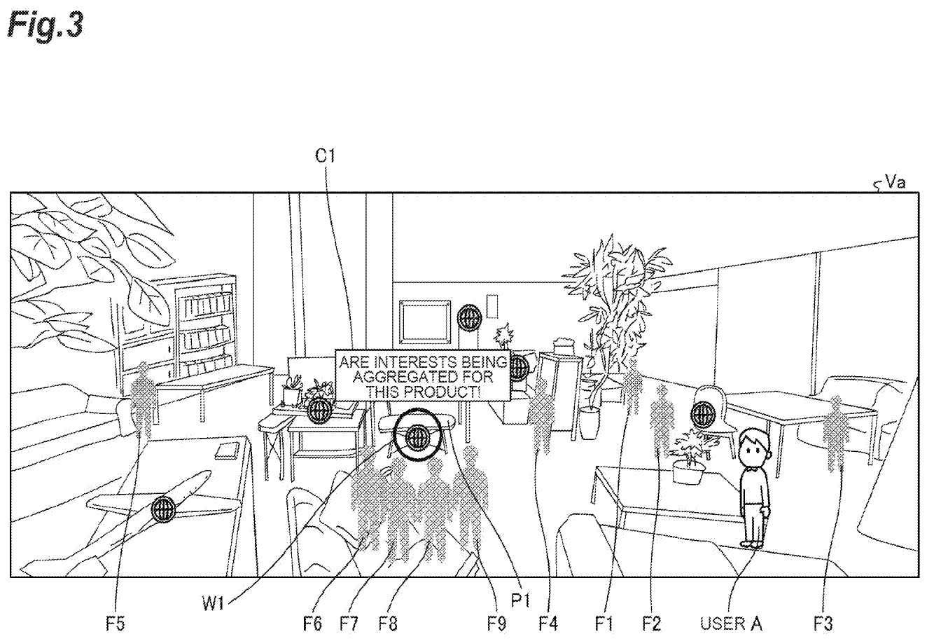

FIG. 3 is a diagram illustrating an example of a screen displayed in the user terminal 20A. As illustrated in a screen Va illustrated in FIG. 3, in the user terminal 20A, an inner view of the VR store in which various products are exhibited is displayed, and an avatar of the user A is displayed on the basis of a position of the user A in the virtual space. In addition, in the screen Va, on the basis of positions of other users in the virtual space, person images F1 to F10 of the users are displayed.

For example, the congestion level display control unit 133 may display the person images F1 to F10 in association with respective persons of other users who have actually entered the VR store. At this time, one user is associated with one image of the person images F1 to F10. In addition, the congestion level display control unit 133 may display the person images F1 to F10 in accordance with a value of the density of users according to the size of the inside of the shop of the VR store in the virtual space. For example, the VR store is divided into lattice shapes, and a density of users of each divided area is calculated. Then, a density of users of a divided area is compared with a predetermined value, and, in a case in which the density of users is a multiple of a predetermined value, person images corresponding to the number of the multiple may be displayed in the divided area. For example, in a case in which the density of users of a certain area is twice the predetermined value, the congestion level display control unit 133 displays two person images in that area.

Then, the congestion level display control unit 133 may regularly acquire a congestion level by regularly acquiring position information of each user in the virtual space from each user terminal 20 and update the positions and the number of person images displayed on the screen of each user terminal 20.

By setting an update interval, for example, in units of seconds, the server apparatus 10 can provide a representation expressed as if person images move inside the VR store for a user. In accordance with this, the user can view movement of person images and thus can recognize movement of other purchasers like in an actual shop. Then, the user can view a degree of aggregation of person images and thus can judge an area of the VR store in which other users gather. In this way, by displaying movement of other users in the VR store, the server apparatus 10 can give a dynamic impression to a user.

The element of interest display control unit 134 identifies a product or an element for which users' interests gather among elements (products and advertisements) disposed at the VR store and performs control such that the identified product or advertisement is displayed with being emphasized in each user terminal 20.

For example, in the example of the screen Va illustrated in FIG. 3, the element of interest display control unit 134 identifies that users' interests gather at a table P1 disposed in an area in which person images F7 to F10 are positioned and encloses a viewing button of this table P1 with a frame line W1, thereby emphasizing the place of this table P1. In addition, by displaying a comment C1 of “Interests gather at this product!”, the element of interest display control unit 134 represents that this table P1 is a product of interest. By only viewing the frame line W1 and the comment C1, the user A can recognize that the product of interest is the table P1. In addition, a target for an emphasized display is not limited to a product but may be an advertisement.

Here, the element of interest display control unit 134 identifies a product or an advertisement at which users' interests gather on the basis of operation of each user for the VR store. This operation information is one or two or more of angle information of a user's visual line through a VR goggle, enlargement operation information of an image through an input device, and position information of a pointer through an input device.

By estimating a position at which visual lines gather using the angle information of a user's visual line through a VR goggle, enlargement operation information of an image through an input device, and position information of a pointer through the input device, the element of interest display control unit 134 identifies a product or an advertisement for which interests gather. Then, the element of interest display control unit 134 displays a product or an advertisement for which interests gather with being emphasized.

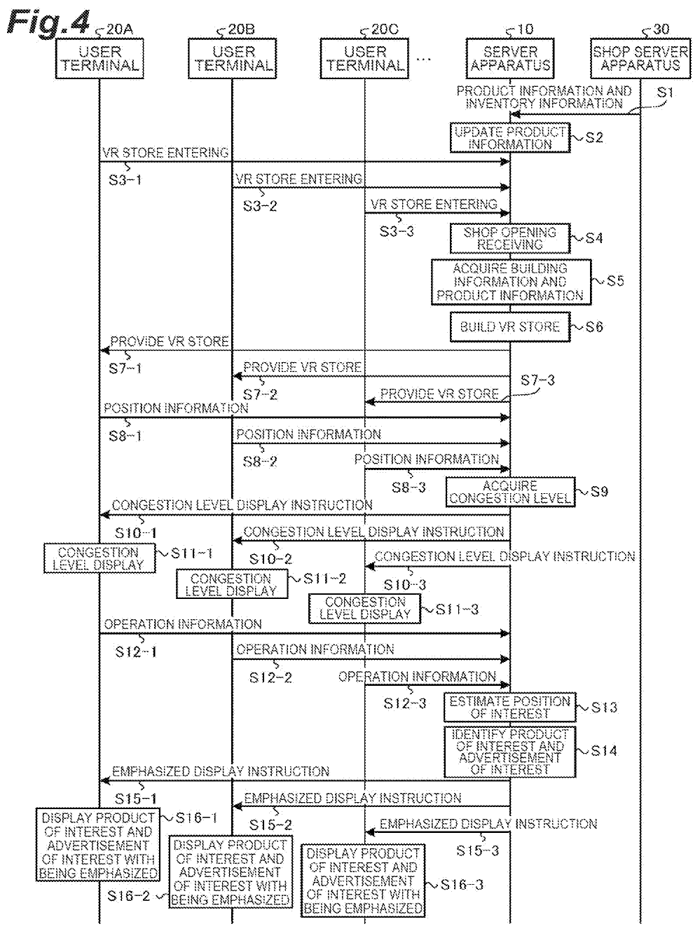

In accordance with this, like an actual shop, a user can judge a product or an advertisement drawing attention from a purchaser, which can be connected to viewing and purchase of a product of interest.

[Processing sequence of communication process] FIG. 4 is a sequence diagram illustrating a processing sequence of a communication process in a communication system according to an embodiment.

As illustrated in FIG. 4, when product information and inventory information are received from the shop server apparatus 30 (Step S1), the server apparatus 10 updates the shop and product information 123 (Step S2).

In the server apparatus 10, when the reception unit 131 receives a shop opening application for a VR store from the user terminals 20A, 20B, and 20C (Steps S3-1, S3-2, S3-3, and S4), the building unit 132 acquires the building information 121 and the shop and product information 123 (Step S5) and builds a VR store in a virtual space (Step S6). Then, the building unit 132 provides the VR store for the user terminals 20A, 20B, and 20C (Steps S7-1, S7-2, and S7-3). In addition, the building unit 132 may build a VR shopping mall in a virtual space and provide the VR shopping mall for the user terminals 20A, 20B, and 20C.

The server apparatus 10 receives position information of each user in the VR store from the user terminals 20A, 20B, and 20C (Steps S8-1, S8-2, and S8-3) and acquires a congestion level of the VR store (Step S9).

Then, the server apparatus 10 instructs the user terminals 20A, 20B, and 20C to display person images corresponding to a number corresponding to the congestion level (Steps S10-1, S10-2, and S10-3). In accordance with this, in each of screens of the user terminals 20A, 20B, and 20C, person images of a number corresponding to the congestion level are displayed (Steps S11-1, S11-2, and S11-3).

The server apparatus 10 receives operation information of respective users for the VR store from the user terminals 20A, 20B, and 20C (Steps S12-1, S12-2, and S12-3), estimates a position at which interests gather (Step S13), and identifies a product or an advertisement for which users' interests gather (Step S14).

Then, the server apparatus 10 instructs the user terminals 20A, 20B, and 20C such that the identified product or advertisement is displayed with being emphasized in each user terminal 20 (Steps S15-1, S15-2, and S15-3). In accordance with this, in each of the screens of the user terminals 20A, 20B, and 20C, a product of interest or an advertisement of interest is displayed with being emphasized (Steps S16-1, S16-2, and S16-3). In the communication system, by regularly updating Steps S8-1 to Step S16-3, a representation expressed as if persons are moving inside the VR store and emphasized display of a latest product of interest or an advertisement of interest are performed.

[Effects of embodiment] In the embodiment, an element (a product or an advertisement) for which users' interests gather among products or advertisements disposed in a VR store is identified, and the identified element is displayed with being emphasized in each user terminal 20. In accordance with this emphasized display, a user can judge one of products and advertisements that is drawing attention and can smoothly advance viewing, purchases, and the like of the product of interest. In this way, according to the embodiment, by enabling a product of interest or an advertisement of interest in a VR store reproduced in a virtual space to be judged, a smooth shopping environment can be provided for a user.

In addition, in this embodiment, a congestion level of a VR store is acquired on the basis of position information of each user at the VR store, and control is performed such that person images of the number corresponding to a congestion level is displayed in each user terminal 20. In accordance with this, a user can view a degree of aggregation of person images, and thus an area of the VR store in which other users gather can be judged. In addition, in this embodiment, by regularly acquiring a congestion level, the positions and the number of person images displayed on the screen of each user terminal 20 may be updated. In accordance with this, according to this embodiment, movement of person images can be viewed, and thus movement of other purchasers can be recognized like in an actual shop.

[System configuration and the like] Each constituent element of each device that has been illustrated is functional and conceptual and does not need to be necessarily physically configured as illustrated in the drawings. In other words, a specific form of distribution/integration of each device is not limited to that illustrated in the drawing, and all or some thereof can be configured with being functionally or physically distributed/integrated in an arbitrary unit in accordance with various loads, a use status, and the like. In addition, the whole or an arbitrary part of each processing function performed in each device may be realized by a CPU and a GPU and programs that are interpreted and executed by the CPU or the GPU or may be realized by hardware according to wired logics.

Furthermore, among processes described in this embodiment, all or some of the processes described to be automatically performed may be manually performed, or all or some of the processes described to be manually performed may be automatically performed using a known method. Other than that, a processing sequence, a control sequence, a specific name, and information including various kinds of data and parameters illustrated in the specification or the drawings described above may be arbitrarily changed unless otherwise mentioned.

[Program] In addition, a program in which the process performed by the server apparatus 10 described in the embodiment described above is described using a computer-executable language may be generated. For example, a program in which the process performed by the server apparatus 10 according to the embodiment is described using a computer-executable language may be generated as well. In such a case, by a computer executing the program, effects similar to those of the embodiment described above can be acquired. In addition, by recording such a program on a computer-readable recording medium and causing a computer to read and execute the program recorded on this recording medium, the process similar to that according to the embodiment described above may be realized.

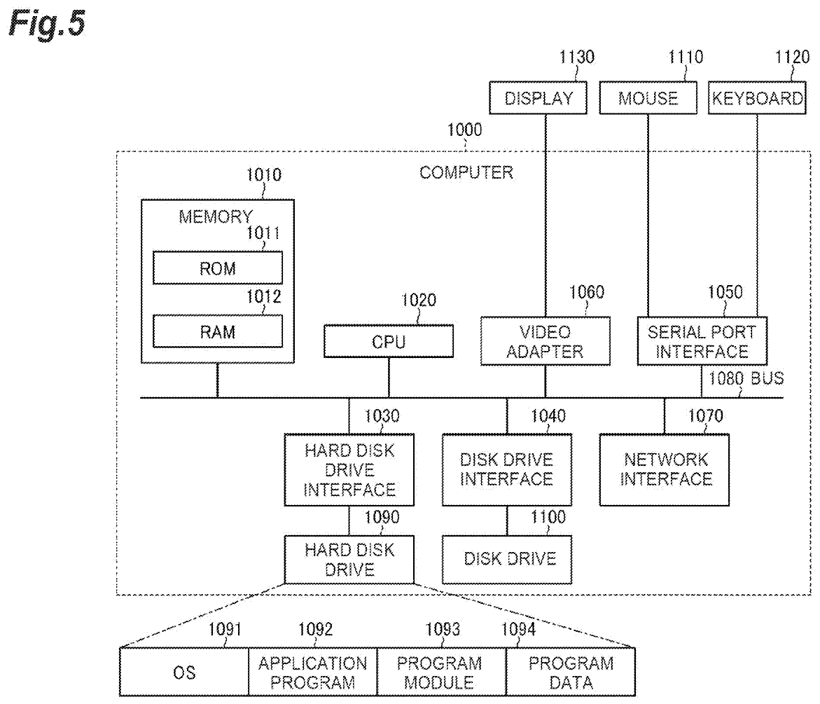

FIG. 5 is a diagram illustrating a computer executing a program. As illustrated in FIG. 5, the computer 1000, for example, includes a memory 1010, a CPU 1020, a hard disk drive interface 1030, a disk drive interface 1040, a serial port interface 1050, a video adaptor 1060, and a network interface 1070, and such units are connected through a bus 1080.

As illustrated in FIG. 5, the memory 1010 includes a read only memory (ROM) 1011 and a RAM 1012. For example, the ROM 1011 stores boot programs such as a Basic Input Output System (BIOS) and the like. As illustrated in FIG. 5, the hard disk drive interface 1030 is connected to a hard disk drive 1090. The disk drive interface 1040 is connected to a disk drive 1100. For example, a loadable/unloadable storage medium such as a magnetic disk, an optical disc, or the like is inserted into the disk drive 1100. For example, the serial port interface 1050 is connected to a mouse 1110 and a keyboard 1120. For example, the video adaptor 1060 is connected to a display 1130.

Here, as illustrated in FIG. 5, the hard disk drive 1090, for example, stores an OS 1091, an application program 1092, a program module 1093, and program data 1094. In other words, the program described above, for example, is stored in the hard disk drive 1090 as a program module in which instructions executed by the computer 1000 are described.

In addition, various kinds of data described in the embodiment described above, for example, is stored in the memory 1010 or the hard disk drive 1090 as program data. Then, the CPU 1020 reads the program module 1093 and the program data 1094 stored in the memory 1010 and the hard disk drive 1090 into the RAM 1012 as necessary and performs various processing sequences.

In addition, the program module 1093 and the program data 1094 relating to the program are not limited to being stored in the hard disk drive 1090 and, for example, may be stored in a loadable/unloadable storage medium and read by the CPU 1020 through a disk drive or the like. Alternatively, the program module 1093 and the program data 1094 relating to the program may be stored in another computer connected through a network (a local area network (LAN), a wide area network (WAN), or the like) and read by the CPU 1020 through the network interface 1070.

Like the embodiment described above and modifications thereof belong to the technology disclosed in the present application, they belong to the scope of inventions described in the claims and equivalency thereof.

### REFERENCE SIGNS LIST

10 Server apparatus
11 Communication unit
12 Storage unit
13 Control unit
20A, 20B, 20C User terminal
30 Shop server apparatus
121 Building information
122 User information
123 Shop and product information
124 User position information
125 User operation information
131 Reception unit
132 Building unit
133 Congestion level display control unit
134 Element of interest display control unit

1. A processing device comprising:
a building unit configured to build a virtual shop at which a user's viewing and purchase of a product can be performed in a virtual space and provide the virtual shop for a user terminal used by each user; and
a first control unit configured to identify an element for which users' interests are aggregated among elements disposed in the virtual shop on the basis of operation information of each user for the virtual shop and perform control such that the identified element is displayed with being emphasized in each user terminal.

2. The processing device according to claim 1, wherein the operation information at least one of angle information of a visual line of a user through VR goggles, enlargement operation information of an image through an input device, and position information of a pointer through an input device.

3. The processing device according to claim 1, wherein the element is a product or an advertisement.

4. The processing device according to claim 1, further comprising a second control unit configured to acquire a congestion level on the basis of position information of each user in the virtual shop and perform control such that person images of the number corresponding to the congestion level are displayed in each user terminal.

5. The processing device according to claim 4, wherein the second control unit regularly acquires the congestion level and updates positions and the number of the person images displayed in each user terminal.

6. A processing method performed by a processing device, the processing method comprising:
a process of building a virtual shop at which a user's viewing and purchase of a product can be performed in a virtual space and providing the virtual shop for a user terminal used by each user; and
a process of identifying an element for which users' interests are aggregated among elements disposed in the virtual shop and performing control such that the identified element is displayed with being emphasized in each user terminal.

7. A non-transitory computer readable storage medium storing a processing program causing a computer to execute steps of:
building a virtual shop at which a user's viewing and purchase of a product can be performed in a virtual space and providing the virtual shop for a user terminal used by each user; and
identifying an element for which users' interests are aggregated among elements disposed in the virtual shop on the basis of operation information of each user for the virtual shop and performing control such that the identified element is displayed with being emphasized in each user terminal.

8. The processing device according to claim 2, wherein the element is a product or an advertisement.

9. The processing device according to claim 2, further comprising a second control unit configured to acquire a congestion level on the basis of position information of each user in the virtual shop and perform control such that person images of the number corresponding to the congestion level are displayed in each user terminal.

10. The processing device according to claim 3, further comprising a second control unit configured to acquire a congestion level on the basis of position information of each user in the virtual shop and perform control such that person images of the number corresponding to the congestion level are displayed in each user terminal.
